(19) United States
(12) Patent Application Publication
(10) Pub. No.: US 2024/0134345 A1
(43) Pub. Date: Apr. 25, 2024

(54) SERVO DRIVER, SERVO SYSTEM, AND SENSOR RECOGNITION PROCESSING METHOD

(71) Applicant: OMRON Corporation, Kyoto-shi, Kyoto (JP)

(72) Inventor: Takeshi KIRIBUCHI, Kyoto-shi, KYOTO (JP)

(21) Appl. No.: 18/548,233

(22) PCT Filed: Dec. 20, 2021
(86) PCT No.: PCT/JP2021/047111

§ 371 Date: Aug. 28, 2023

(30) Foreign Application Priority Data
Mar. 14, 2021 (JP) 2021-041194

(51) Int. Cl. G05B 19/414

(52) U.S. Cl. CPC G05B 19/4141; G05B 19/4144

(57) ABSTRACT

A servo driver is configured to drive a first motor and be communicatively connected to a different servo driver. The servo driver and a first sensor that is configured to detect a parameter relating to displacement of a first drive target driven via an output axis of a first motor are in an arrangement such that a detection signal from the first sensor is received by the servo driver. In a case in which the servo driver receives the detection signal from the first sensor when a first predetermined operation of driving only the output axis of the first motor to displace the first drive target is performed in a state in which sensor recognition processing is not complete, the servo driver recognizes the first sensor as a first corresponding sensor associated with the servo driver.

### TECHNICAL FIELD

The present invention relates to a servo driver, a servo system, and a sensor recognition processing method.

### BACKGROUND ART

In a servo system, servo control is generally performed on a servo motor by a servo driver in response to a command from a controller such as a PLC. In servo control, a detection signal from an external sensor different to the encoder in the servo motor may be used. Examples of the external sensor include a limit sensor that detects a specific position of a drive target driven by a motor. Such a known external sensor is connected to the servo driver by a sensor cable. However, the servo driver may be located at a distance from the servo motor at the location where the servo system is used, due to the layout of the location or other factors. In such a case, the cable connecting the servo driver and the servo motor needs to be relatively long. On the other hand, the external sensor used for detecting movement of the drive target needs to be disposed near the drive target.

When the distance between the servo motor and the servo driver is long, the sensor cable connecting the sensor and the servo driver is also long. A long sensor cable is disadvantageous in that, for example, wiring the sensor cable (e.g., connecting or laying the sensor cable) requires significant effort. To address this, Patent Document 1 describes a technique of using a cable to connect the sensor to an encoder of a servo motor disposed near the sensor, and transmitting detection signals from the sensor and feedback signals generated by the encoder from the encoder to a servo driver. According to this technique, detection signals from the sensor can be transmitted to the servo driver since the sensor is connected to the encoder, and the wiring connecting the sensor and the servo driver can be kept shorter.

### CITATION LIST

### Patent Literature

Patent Document 1: JP 6349687 B

### SUMMARY OF INVENTION

### Technical Problem

According to known techniques, a sensor and an encoder are wired together such that detection signals from the sensor, which detects parameters used by the servo driver, are input to the servo driver. In this case, for a servo system including a plurality of servo drivers, when a sensor directly related to displacement of a drive target generated by a motor including the encoder is connected to an encoder different from the encoder (i.e., the encoder of a motor for another drive axis), the servo driver requiring the detection signal from the sensor needs to acquire the necessary information from a different servo driver (i.e., the servo driver that receives output from the different encoder).

For the servo driver to appropriately acquire the detection signal from the corresponding sensor, the servo driver and the sensor need to be associated with each other. In other words, the servo driver needs to perform processing for recognizing the corresponding sensor. Even if the user wires the sensor and the encoder using a known technique to alleviate the burden of wiring, the work of setting the association between the servo driver and the sensor may remain a burden and user-friendliness may be lost.

The present invention has been made in consideration of the aforementioned problems, and an object of the present invention is to provide a technique for performing sensor recognition processing by a servo driver in a servo system including a plurality of servo drivers.

### Solution to Problem

A servo driver according to an aspect of the present invention is configured to drive a first motor and be communicatively connected to a different servo driver. The servo driver and a first sensor that is configured to detect a parameter relating to displacement of a first drive target driven via an output axis of the first motor are in an arrangement such that a detection signal from the first sensor is received by the servo driver. The different servo driver and a different sensor that is configured to detect a different parameter relating to displacement of the first drive target are in an arrangement such that a detection signal from the different sensor is received by the different servo driver. The servo driver includes a first processing unit configured to, in a case in which the servo driver receives a detection signal from the first sensor when a first predetermined operation of driving only the output axis of the first motor to displace the first drive target is performed in a state in which sensor recognition processing is not complete, recognize the first sensor as a first corresponding sensor associated with the servo driver, and a second processing unit configured to, in a case in which the servo driver receives, from the different servo driver, predetermined information relating to the different sensor for enabling the servo driver to recognize the different sensor as a different corresponding sensor associated with the servo driver when the first predetermined operation is performed in a state in which sensor recognition processing is not complete, recognize the different sensor as the different corresponding sensor on the basis of the predetermined information.

The servo driver and the different servo driver form a servo system. The servo drivers are communicatively connected to each other, and information required for servo control performed by each servo driver can be exchanged between both servo drivers. Here, the first motor driven and controlled by the servo driver is disposed so as to drive the first drive target, and a parameter relating to displacement of the first drive target is detected by a sensor different from the first sensor. The first sensor is received by the servo driver and the different sensor is received by the different servo driver in this arrangement. In other words, in this arrangement, while the detection signal from the first sensor is directly received by the servo driver that drives and controls the first motor, the detection signal from the different sensor is not received by the servo driver and is received by the different servo driver. Note that examples of the first sensor and the different sensor include sensors relating to the position of the first drive target, such as an origin sensor, a limit sensor, and a closed sensor paired with a linear scale.

In this manner, for the servo driver to use the detection signal from the sensor different from the first sensor, sensor recognition processing performed by the servo driver is required so that the different servo driver that has received the detection signal from the different sensor can appropriately transmit the presence of the different sensor to the servo driver. Thus, the servo driver implements the sensor recognition processing using the first processing unit and the second processing unit described above. In the processing performed by both processing units, the first predetermined operation of the first motor is executed by the servo driver. In the first predetermined operation, only the first motor is driven, and when there is another drive axis in the servo system, the other motor is not driven. Thus, a case in which a sensor acquires any detection signal during the period in which the first predetermined operation is performed means that the sensor is a sensor relating to the first motor, that is, a sensor corresponding to the servo driver that drives and controls the first motor. Note that the first predetermined operation may be an operation in which the first drive target moves a full drivable range of the first drive target starting from one end portion and reaching another end portion, or may be another operation.

Thus, during the period in which the first predetermined operation is performed, in a case in which the first processing unit receives the detection signal from the first sensor, the first processing unit recognizes the first sensor as a sensor (corresponding sensor) corresponding to the servo driver. Furthermore, during the same period in which the first predetermined operation is performed, in a case in which the second processing unit receives predetermined information relating to the different sensor from the different servo driver, the second processing unit also recognizes the different sensor as a sensor (corresponding sensor) corresponding to the servo driver. The predetermined information is a signal for enabling the servo driver to recognize the different sensor as a sensor corresponding to the servo driver and is transmitted from a servo driver different from the servo driver (the different servo driver). Note that in this case, since the first predetermined operation is being performed, the different servo driver can recognize that the different sensor does not correspond to the different servo driver but cannot recognize which servo driver the different sensor corresponds to. Thus, the predetermined information cannot include information that directly specifies a corresponding servo driver. However, since the predetermined information is transmitted in relation to the first predetermined operation, when the servo driver performing at least the first predetermined operation receives the predetermined information, the servo driver can recognize that the different sensor according to the predetermined information is a sensor corresponding to the servo driver.

As described above, by using the first processing unit and the second processing unit, the servo driver can suitably recognize the first sensor disposed so as to be directly received by the servo driver that drives and controls the first motor via the first predetermined operation of the first motor and the different sensor disposed so as not to be received by the servo driver but to be received by the different servo driver.

The servo driver and a second sensor that is configured to detect a parameter relating to displacement of a second drive target driven via an output axis of the second motor by a second servo driver communicatively connected to the servo driver may be in an arrangement such that a detection signal from the second sensor is received by the servo driver. In this case, the servo driver may further include a transmitting unit configured to, in a case in which the servo driver receives the detection signal from the second sensor when a second predetermined operation of driving only the output axis of the second motor to displace the second drive target is performed in a state in which the sensor recognition processing is not complete, transmit to the second servo driver information relating to the second sensor for enabling the second servo driver to recognize the second sensor as a second corresponding sensor associated with the second servo driver.

In this case, the second sensor unrelated to the servo driver is received by the servo driver in this arrangement. That is, in this arrangement, the detection signal from the second sensor is not directly received by the second servo driver but is received by the servo driver. Thus, when the second predetermined operation of driving only the second motor is performed, the detection signal from the second sensor is input into the servo driver without being input into the second servo driver. The second predetermined operation relates to the second motor and is similar to the first predetermined operation described above. Thus, when the servo driver transmits the information relating to the second sensor to the second servo driver via the transmitting unit, the second servo driver that receives the information can recognize the second sensor as a sensor that corresponds to the second servo driver on the basis of the received information relating to the second predetermined operation. In this manner, the servo driver can use the transmitting unit to assist the recognition processing of the corresponding sensor relating to the servo driver different from the servo driver (second servo driver). Note that the different servo driver may be the second servo driver.

Here, multiple examples of the path of transmitting detection signals from the sensor to the servo drivers are given. In a first example, the first motor may include a motor body including the output axis and an encoder including a signal generation unit configured to detect an operation of the motor body driven by the servo driver and generate a feedback signal indicating a detected operation. In this case, the first sensor may be connected to the encoder via a sensor cable, and the servo driver may acquire, via a communication cable connected to the encoder, the feedback signal generated by the signal generation unit and a detection signal from the first sensor transmitted via the sensor cable. In this manner, since the encoder and the first sensor are wired together via the sensor cable and the feedback signal and the detection signal from the first sensor are transmitted to the servo driver via the communication cable, the burden of wiring sensors can be reduced. Note that the second sensor and the encoder may also be connected via the sensor cable, and in a similar manner, the feedback signal and the detection signal from the second sensor may be transmitted to the servo driver via the communication cable.

Note that in this case, the first sensor may be supplied with electric power from the encoder via the sensor cable. This arrangement eliminates the need to provide a power supply in the sensor. Also, the encoder may include a display unit configured to indicate, when a detection signal is input from the first sensor via the sensor cable, that the input is received. According to this configuration, the user can visually recognize the input of the detection signal from the first sensor on the basis of the display content of the display unit.

Next, according to a second mode, the first sensor may be wirelessly communicatively connected to the servo driver or wirelessly communicatively connected to the servo driver via a predetermined device configured to communicate with the first sensor. In this case, the servo driver may wirelessly acquire a detection signal from the first sensor or may acquire a detection signal from the first sensor via the predetermined device. By using wireless communication, the burden of wiring the sensors can be reduced. Note that the second sensor may also wirelessly transmit a detection signal to the servo driver.

The servo driver described above may further include a judgment unit configured to judge a sensor type of the first sensor recognized by the first processing unit and the different sensor recognized by the second processing unit, on the basis of position information in a drive range of the first drive target when each of the first sensor and the different sensor is recognized. By judging the sensor type in the recognition processing of the corresponding sensor, user-friendliness can be further improved.

Also, the servo driver according to the present application can be implemented according to another aspect. For example, the servo driver may be configured to drive the first motor. Further, the first motor may include a motor body including an output axis and an encoder including a signal generation unit configured to detect an operation of the motor body driven by the servo driver and generate a feedback signal indicating a detected operation. A first sensor configured to detect a parameter relating to displacement of a first drive target driven via the output axis of the first motor may be connected to the encoder via a sensor cable, and via this connection, the detection signal from the first sensor may be transmitted to the encoder and the first sensor may be supplied with electric power from the encoder via the sensor cable, and the servo driver may acquire, via a communication cable connected to the encoder, the feedback signal generated by the signal generation unit and a detection signal from the first sensor transmitted via the sensor cable.

Also, the present invention can be implemented according to an aspect of a servo system. In other words, the servo system includes a first servo driver configured to drive a first motor and a second servo driver communicatively connected to the first servo driver and configured to drive a second motor. The first servo driver is configured to receive a detection signal from a first sensor configured to detect a parameter relating to displacement of a first drive target driven via an output axis of the first motor, and the second servo driver is configured to receive a detection signal from a different sensor configured to detect a different parameter relating to displacement of the first drive target. Furthermore, the second servo driver is configured to, in a case in which the second servo driver receives the detection signal from the different sensor when a first predetermined operation of driving only the output axis of the first motor to displace the first drive target is performed in a state in which sensor recognition processing is not complete, transmit to the first servo driver information relating to the different sensor for enabling the first servo driver to recognize the different sensor as a different corresponding sensor associated with the first servo driver. The first servo driver is configured to recognize the different sensor as the different corresponding sensor on the basis of the information relating to the different sensor. According to such a configuration, via the first predetermined operation of the first motor, the first servo driver can suitably recognize the different sensor which is disposed so as not to be received by the first servo driver that drives and controls the first motor but to be received by the second servo driver.

Also, in the servo system described above, the first servo driver may be further configured to, in a case in which the first servo driver receives the detection signal from the first sensor when the first predetermined operation is performed in a state in which sensor recognition processing is not complete, recognize the first sensor as a first corresponding sensor associated with the first servo driver. According to such a configuration, via the first predetermined operation of the first motor, the first servo driver can suitably recognize the first sensor which is disposed so as be directly received by the servo driver that drives and controls the first motor.

Further, the described technical concept of the servo driver described above can be applied to the servo system described above as long as no technical inconsistency arises.

Also, the present invention can be implemented according to an aspect of a sensor recognition processing method. In other words, the sensor recognition processing method is a sensor recognition processing method executed by a servo system including a first servo driver configured to drive a first motor and a second servo driver communicatively connected to the first servo driver and configured to drive a second motor. The first servo driver is configured to receive a detection signal from a first sensor configured to detect a parameter relating to displacement of a first drive target driven via an output axis of the first motor, and the second servo driver is configured to receive a detection signal from a different sensor configured to detect a different parameter relating to displacement of the first drive target. Furthermore, the method includes transmitting, in a case in which the second servo driver receives the detection signal from the different sensor when a first predetermined operation of driving only the output axis of the first motor to displace the first drive target is performed in a state in which sensor recognition processing is not complete, from the second servo driver to the first servo driver information relating to the different sensor for enabling the first servo driver to recognize the different sensor as a different corresponding sensor associated with the first servo driver, and recognizing the different sensor as the different corresponding sensor on the basis of the information relating to the different sensor by the first servo driver. According to such a configuration, via the first predetermined operation of the first motor, the first servo driver can suitably recognize the different sensor which is disposed so as not to be received by the first servo driver that drives and controls the first motor but to be received by the second servo driver.

Also, the sensor recognition processing method described above may further include, in a case in which the first servo driver receives the detection signal from the first sensor when the first predetermined operation is performed in a state in which sensor recognition processing is not complete, recognizing, by the first servo driver, the first sensor as a first corresponding sensor associated with the first servo driver. According to such a configuration, via the first predetermined operation of the first motor, the first servo driver can suitably recognize the first sensor which is disposed so as be directly received by the servo driver that drives and controls the first motor.

Further, the described technical concept of the servo driver described above can be applied to the sensor recognition processing method described above as long as no technical inconsistency arises.

### Advantageous Effects of Invention

Sensor recognition processing by a servo driver in a servo system including a plurality of servo drivers can be implemented.

### BRIEF DESCRIPTION OF DRAWINGS

FIG. 1 is a first diagram illustrating a schematic configuration of a servo system according to an embodiment of the present invention.

FIG. 2 is a first diagram illustrating a schematic configuration of a motor.

FIG. 3 is a diagram illustrating a functional configuration of a servo driver.

FIG. 4 is a flowchart illustrating the flow of processing performed by drivers when performing sensor recognition processing.

FIG. 5 is a flowchart illustrating a specific flow of processing performed between the PLC and the servo driver when the sensor recognition processing of the flowchart illustrated in FIG. 4 is performed.

FIG. 6 is a second diagram illustrating a schematic configuration of a servo system according to an embodiment of the present invention.

FIG. 7 is a third diagram illustrating a schematic configuration of a servo system according to an embodiment of the present invention.

FIG. 8 is a fourth diagram illustrating a schematic configuration of a servo system according to an embodiment of the present invention.

### DESCRIPTION OF EMBODIMENTS

Hereinafter, embodiments of the present invention will be described in detail with reference to the drawings. Note that the same or corresponding parts in the drawings are denoted by the same reference sign, and description thereof will not be repeated. In the present disclosure, an industrial system is used as one example of a mode of a servo system. However, the application of the servo system according to the present invention is not particularly limited.

### First Embodiment

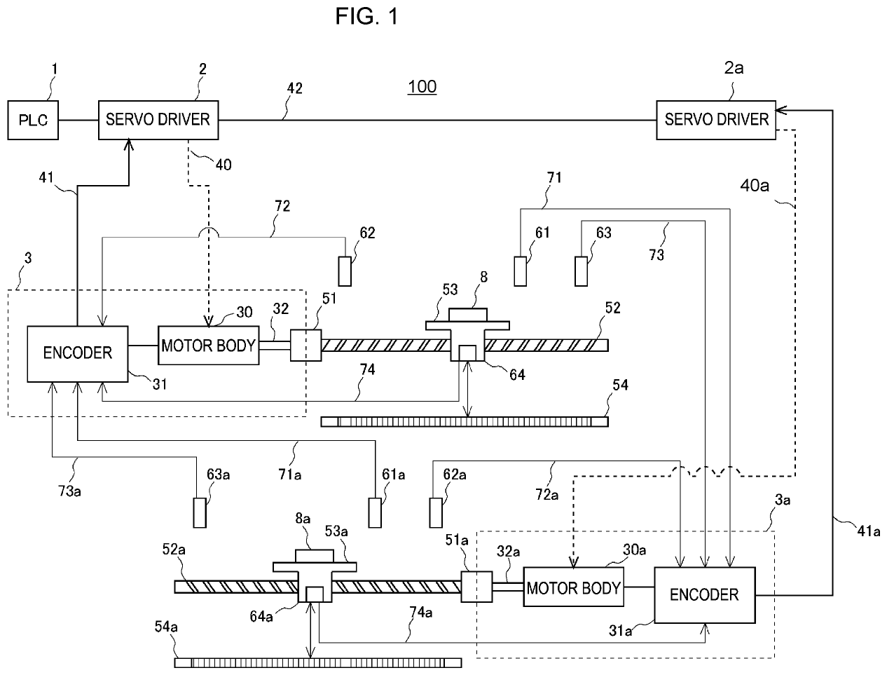

FIG. 1 is a block diagram schematically illustrating an example of the configuration of a servo system 100. Referring to FIG. 1, the servo system 100 includes a programmable logic controller (PLC) 1 and servo drivers 2 and 2a. The servo drivers 2 and 2a are disposed to drive and control servo motors 3 and 3a, respectively. Output axes 32 and 32a of the servo motors 3 and 3a are connected to threaded axes 52 and 52a by couplings 51 and 51a, respectively. Precision stages 53 and 53a are disposed at the threaded axes 52 and 52a, respectively. The precision stages 53 and 53a are configured to be displaced when the servo motors (hereinafter referred to as “motor”) 3 and 3a are driven, respectively. Workpieces 8 and 8a are placed on the precision stages 53 and 53a, respectively. In this manner, in the illustrated servo system 100, two drive axes, that is, the drive axis of the motor 3 and the drive axis of the motor 3a are provided, but three or more drive axes may be provided.

Also, a linear scale 54, an origin sensor 61, limit sensors 62 and 63, and a full-closed sensor 64 are disposed at the drive axis of the motor 3, and a linear scale 54a, an origin sensor 61a, limit sensors 62a and 63a, and a full-closed sensor 64a are disposed at the drive axis of the motor 3a. These sensors detect parameters relating to the displacement of the precision stages 53 and 53a, which are detection targets.

The origin sensors 61 and 61a detect the origin positions of the precision stages 53 and 53a, respectively. Each origin sensor 61, 61a outputs an ON signal when the stage is at a origin position, and outputs an OFF signal when the stage is at any other position. The limit sensors 62 and 63, 62a and 63a detect the end portion positions of the movable ranges of the precision stages 53 and 53a in the drive axis, respectively. Each limit sensor 62, 63, 62a, 63a outputs an ON signal when the stage is at the end portion position, and outputs an OFF signal when the stage is at any other position. In this configuration, for example, when the limit sensor 62 turns ON, the motor 3 stops and thus the precision stage 53 stops. A photoelectric sensor, a proximity sensor, a fiber sensor, or the like can be used as the origin sensor or the limit sensor. Also, in an example using another method, an image sensor may be used as the origin sensor or the limit sensor. In this case, each sensor outputs an image signal as the detection signal.

The linear scales 54 and 54a are installed aligned with the axial directions of the threaded axes 52 and 52a, respectively. The linear scale 54, 54a is, for example, a reflective photoelectric glass scale and is provided with equal-pitch slits. The full-closed sensors 64 and 64a are installed on the precision stages 53 and 53a and move integrally with the precision stages 53 and 53a, respectively. Each of the full-closed sensors 64, 64a includes a light-emitting portion and a light-receiving portion (not illustrated). The light emitted from the light-emitting portion is reflected at the slit of the corresponding linear scale 54, 54a, generating interference fringes on the light-receiving portion. When the precision stage 53, 53a moves, the interference fringes also move. Thus, the intensity of the output signal from the light-receiving portion changes as the precision stage 53, 53a moves. In this manner, the amount of movement of the precision stage 53, 53a can be determined by monitoring the change in intensity of the output signal from the light-receiving portion. In other words, the full-closed sensor 64, 64a outputs a detection signal used for calculating the amount of movement of the precision stage 53, 53a, and the detection signal is used in the full-closed control by the servo driver 2, 2a.

Here, the PLC 1 outputs a command signal to the servo drivers 2 and 2a. The PLC 1 functions as, for example, a monitoring device that monitors the servo drivers 2 and 2a by performing processing according to a pre-prepared program.

The servo drivers 2 and 2a receive command signals from the PLC 1. Furthermore, the servo drivers 2 and 2a receive feedback signals from the motors 3 and 3a and receive detection signals output from the corresponding origin sensors 61 and 61a, the limit sensors 62 and 63, 62a and 63a, or the full-closed sensors 64 and 64a, respectively. Each servo driver 2, 2a includes a servo system that performs feedback control using a position controller, a speed controller, a current controller, and the like. These signals are used to perform servo control and drive the motor 3, 3a.

The motor 3 includes a motor body 30 and an encoder 31, and the motor 3a includes a motor body 30a and an encoder 31a. The motors 3 and 3a are, for example, AC servo motors. The motors 3 and 3a are supplied with a drive current from the servo drivers 2 and 2a via power lines 40 and 40a, respectively. The encoders 31 and 31a detect the operations of the motor bodies 30 and 30a, respectively. The encoders 31 and 31a output feedback signals indicating the detected operations to the servo drivers 2 and 2a via encoder cables 41 and 41a, respectively.

Next, wiring of each sensor will be described. As described above, the origin sensor 61, the limit sensors 62 and 63, and the full-closed sensor 64 are assigned to the drive axis relating to the motor 3, and the origin sensor 61a, the limit sensors 62a and 63a, and the full-closed sensor 64a are assigned to the drive axis relating to the motor 3a. However, in the configuration illustrated in FIG. 1, the sensor cable connected to each sensor is not necessarily connected to the encoder of the motor related to the drive axis to which each sensor is assigned and is connected to the encoder of the motor closest to the sensor. For example, the encoder 31a is arranged closer to the origin sensor 61 and the limit sensor 63 assigned to the motor 3 than the encoder 31. Thus, in this embodiment, a cable 71 connected to the origin sensor 61 and a cable 73 connected to the limit sensor 63 are connected to the encoder 31a. This configuration is realized when a plurality of encoders are provided.

In a similar manner, the origin sensor 61a and the limit sensor 63a are assigned to the motor 3a, but the encoder 31 is arranged closer to the origin sensor 61a and the limit sensor 63a than the encoder 31a. Thus, in this embodiment, a cable 71a connected to the origin sensor 61a and a cable 73a connected to the limit sensor 63a are connected to the encoder 31.

Note that the remaining sensors (the limit sensor 62, the full-closed sensor 64, the limit sensor 62a, and the full-closed sensor 64a) can also be connected, via a cable, to whichever of the encoders 31 and 31a that is closest to each of the remaining sensors. However, in the configuration illustrated in FIG. 1, the limit sensor 62 and the full-closed sensor 64 are connected to the encoder 31 via cables 72 and 74, respectively, and the limit sensor 62a and the full-closed sensor 64a are connected to the encoder 31a via the cables 72a and 74a, respectively. In other words, for these sensors, the closest encoder is also the encoder that detects the operations of the motor to which the sensor is assigned.

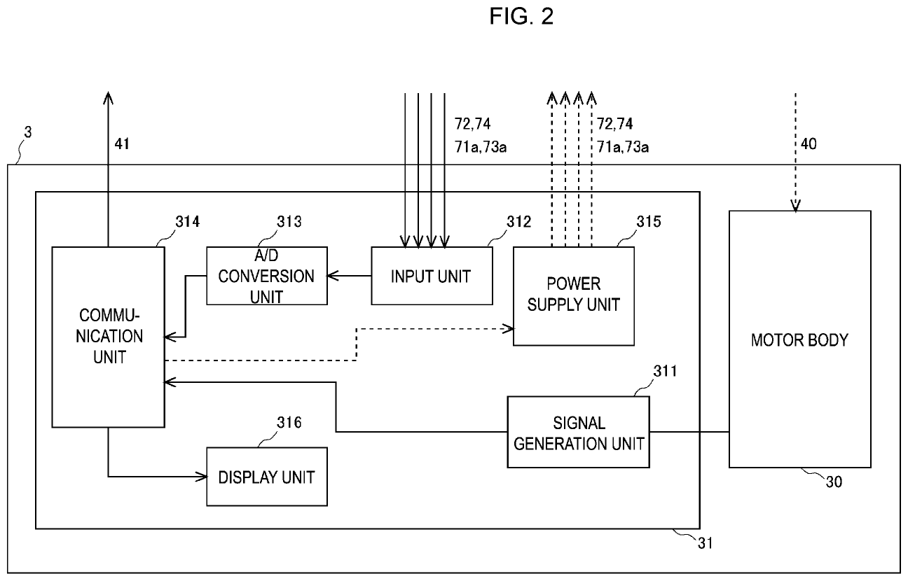

Next, the functional configuration of each of the encoders 31 and 31a connected to the sensors via cables as described above will be described with reference to FIG. 2. Note that FIG. 2 schematically illustrates a representative example of the configuration of the encoder 31, and the encoder 31a has substantially the same functional configuration. The encoder 31 includes a signal generation unit 311, an input unit 312, an analog-digital (A/D) conversion unit 313, a communication unit 314, a power supply unit 315, and a display unit 316.

The signal generation unit 311 detects the operations of the motor body 30 of the motor 3 driven by the servo driver 2 and generates a feedback signal indicating the detected operation. The feedback signal is output to the communication unit 314. The feedback signal includes information relating to the rotational position (angle) of the rotary axis of the motor body 30, information relating to the rotational speed of the rotary axis, and information relating to the rotation direction of the rotary axis. A known incremental-type signal generation unit or absolute-type signal generation unit can be used as the configuration of the signal generation unit 311.

Detection signals from each sensor are input into the input unit 312. In the encoder 31 of the present embodiment, the cable 72 of the limit sensor 62, the cable 74 of the full-closed sensor 64, the cable 71a of the origin sensor 61a, and the cable 73a of the limit sensor 63a are connected to the input unit 312. The input unit 312 is, for example, a terminal block or a connector for connecting wiring. The input unit 312 functions as an input interface for receiving detection signals from the sensors via the cables. The input detection signals are output from the input unit 312 to the A/D conversion unit 313. The A/D conversion unit 313 performs A/D conversion on the detection signals from the input unit 312 and outputs the converted digital signals to the communication unit 314.

The communication unit 314 is an interface for communicating with the servo driver 2. In the present embodiment, the communication unit 314 transmits the feedback signals and the detection signals from the sensors to the servo driver 2 via the encoder cable 41. Note that in the encoder 3a, the feedback signals and the detection signals from the sensors are transmitted to the servo driver 2a via the encoder cable 41a. In this embodiment, serial communication is used as the mode of transmitting the feedback signals and the detection signals from the communication unit 314. Thus, the number of signal lines included in the cable can be reduced. For serial communication via the encoder cable 41, a known communication standard such as Recommended Standards 232 (RS-232C), RS-422, or RS-485 can be used. Furthermore, the encoder 31 is supplied with electric power from the servo driver 2 via the encoder cable 41.

The power supply unit 315 is a functional unit that supplies some of the electric power obtained from the servo driver 2 via the encoder cable 41 to each sensor connected by a cable. Some of the electric power is transferred from the communication unit 314 to the power supply unit 315. Note that in FIG. 2, the cables connected to the input unit 312 and the cables connected to the power supply unit 315 are illustrated separately, but in practice, detection signals from the sensors are received and electric power is supplied via the same cable. Also, in an example using another method, different cables may be wired to connect the sensors with the input unit 312 and the power supply unit 315.

The display unit 316 is an LED that lights up in response to detection signals being input from the sensors to the input unit 312. That is, LEDs are arranged in the encoder 31 in a number corresponding to the number of cables of the sensors connected to the encoder 31, and when a detection signal is input, the LED corresponding to the sensor that has transmitted the detection signal lights up. Note that the display unit 316 may be a liquid crystal display or the like instead of an LED, and in this case, the sensor from which the detection signal has been input may be displayed on the display.

In the servo system 100, in a state in which the servo driver 2, 2a can perform servo control on the corresponding motor 3, 3a, the encoder 31, 31a has an operation mode that supports usage with the servo drivers 2 and 2a in a communicative state. In this operation mode, the encoder 31, 31a transmits detection signals from the sensors to a servo driver, and the detection signal is required to reach a specific servo driver that requires the detection signal. The servo driver 2 and the servo driver 2a are connected by a communication cable 42. One of the servo drivers 2 and 2a transmits the detection signals from the sensors to the other of the servo drivers 2 and 2a that needs the detection signals, or the servo driver 2, 2a receives the detection signals itself.

For example, the servo driver 2 receives, from the encoder 31, detection signals from the limit sensor 62, the full-closed sensor 64, the origin sensor 61a, and the limit sensor 63a. The detection signals from the limit sensor 62 and the full-closed sensor 64 are signals to be processed at the servo driver 2, and the detection signals from the origin sensor 61a and the limit sensor 63a are signals to be processed at the servo driver 2a. Accordingly, the servo driver 2 transfers the detection signals from the origin sensor 61a and the limit sensor 63a to the servo driver 2a.

In a similar manner, the servo driver 2a receives, from the encoder 31a, the detection signals from the origin sensor 61, the limit sensor 63, the limit sensor 62a, and the full-closed sensor 64a. The detection signals from the limit sensor 62a and the full-closed sensor 64a are signals to be processed at the servo driver 2a, and the detection signals from the origin sensor 61 and the limit sensor 63 are signals to be processed at the servo driver 2. Accordingly, the servo driver 2a transfers the detection signals from the origin sensor 61 and the limit sensor 63 to the servo driver 2.

To distribute the detection signals among the servo drivers in this manner, the sensor transmitting the detection signal and the servo driver corresponding to the destination of the detection signal need to be associated with each other. In other words, the servo driver needs to perform recognition processing of the corresponding sensor (sensor corresponding to the servo driver). The recognition processing will be described below.

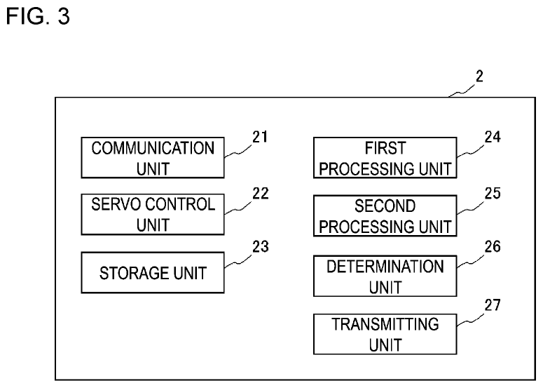

FIG. 3 illustrates a schematic configuration of the functional units included in the servo driver 2. The servo driver 2 can be regarded as a computer including an arithmetic device and a storage device, and the functional units illustrated in FIG. 3 are implemented by a predetermined program or the like being executed at the servo driver 2. Note that the servo driver 2a includes similar functional units and hence the servo driver 2a will not be described in detail. The servo driver 2 includes a communication unit 21, a servo control unit 22, a storage unit 23, a first processing unit 24, a second processing unit 25, a judgment unit 26, and a transmitting unit 27, and may also include other functional units.

The communication unit 21 is a function unit for managing communication with an external device via the communication cable 42. For example, the communication unit 21 functions as an interface for communication with the PLC 1 or another servo driver (e.g., the servo driver 2a). Further, the communication unit 21 also functions as an interface for communication with the encoder 31 via the encoder cable 41. The servo control unit 22 is a functional unit for performing servo control on the motor 3 on the basis of a command from the PLC 1. Specifically, the servo control unit 22 is a functional unit that performs feedback control using a position controller, a speed controller, or a current controller, and uses the detection signals from the sensors assigned to the servo driver 2 for feedback control. For the position controller, the speed controller, or the current controller, control parameters such as speed gain are set as appropriate such that servo control is suitably performed on the motor 3, which is the control target. The storage unit 23 is a functional unit that stores information relating to processing performed by the servo driver 2, such as information necessary for servo control of the motor 3, and information necessary for recognition processing of the corresponding sensor performed by the servo driver. Note that information (correspondence information) indicating the association between the servo driver and each of the sensors, which is determined by recognition processing of the corresponding sensor to be described later, is stored in the storage unit 23. Then, on the basis of the stored correspondence information, the servo driver 2 performs processing to determine destinations for the detection signals transmitted from the sensors and transmit, via the communication unit 21, a detection signal from a specific sensor to the servo driver set as the destination as necessary.

The first processing unit 24 is a functional unit that, in a case in which a detection signal is received from a specific sensor when a first predetermined operation of driving the output axis 32 of the motor 3 to displace the precision stage 53 is performed, recognizes the specific sensor as the corresponding sensor to be associated with the servo driver 2. The specific sensor is a sensor disposed such that, despite not yet being subject to recognition processing by the servo driver 2, the detection signal from the sensor is received by the servo driver 2, and is the sensor ultimately to be assigned to the servo driver 2. In the case of the present embodiment, the specific sensor corresponds to the limit sensor 62 and the full-closed sensor 64. Note that the first predetermined operation is an operation in which the precision stage 53 moves the full drivable range of the precision stage 53 starting from one end portion and reaching the other end portion.

The second processing unit 25 is a functional unit that, in a case in which information relating to a sensor different from the specific sensor is received from a servo driver different from the servo driver 2 (in the case of the present embodiment, the servo driver 2a) when the first predetermined operation is performed, recognizes the sensor different from the specific sensor as the corresponding sensor to be associated with the servo driver 2 on the basis of the received information. The sensor different from the specific sensor is a sensor disposed such that, despite not yet being subject to recognition processing by the servo driver 2, the detection signal from the sensor is received by the servo driver 2a, and is the sensor ultimately to be assigned to the servo driver 2. In the case of the present embodiment, the sensor different from the specific sensor corresponds to the origin sensor 61 and the limit sensor 63. Note that information relating to the origin sensor 61 and the limit sensor 63 is transmitted from the servo driver 2a to the servo driver 2 by the transmitting unit 27 (described below) included in the servo driver 2a.

The judgment unit 26 is a functional unit that judges the sensor type of the sensor recognized by the first processing unit 24 and the sensor recognized by the second processing unit 25 on the basis of the position information of the precision stage 53 when each sensor is recognized. Since the detection signals from the origin sensor 61, the limit sensor 62, 63, and the full-closed sensor 64 fluctuate in response to the displacement of the precision stage 53, the detection signals are strongly correlated with the position of the precision stage 53. The judgment processing of the sensor type by the judgment unit 26 is performed using this correlation.

The transmitting unit 27 is a functional unit that, in a case in which a detection signal is received from a specific sensor when a second predetermined operation of driving only the output axis of the motor 3a corresponding to the servo driver different from the servo driver 2 (in the case of the present embodiment, the servo driver 2a) to displace the precision stage 53a is performed, transmits, to the servo driver 2a, information relating to the specific sensor for enabling the servo driver 2a to recognize the specific sensor as the sensor associated with the servo driver 2a. The specific sensor is a sensor disposed such that, despite not yet being subject to recognition processing by the servo driver 2a, the detection signal from the sensor is received by the servo driver 2, and is the sensor ultimately to be assigned to the servo driver 2a. In the case of the present embodiment, the specific sensor corresponds to the origin sensor 61a and the limit sensor 63a. Note that the second predetermined operation is an operation in which the precision stage 53a moves the full drivable range of the precision stage 53a starting from one end portion and reaching the other end portion.

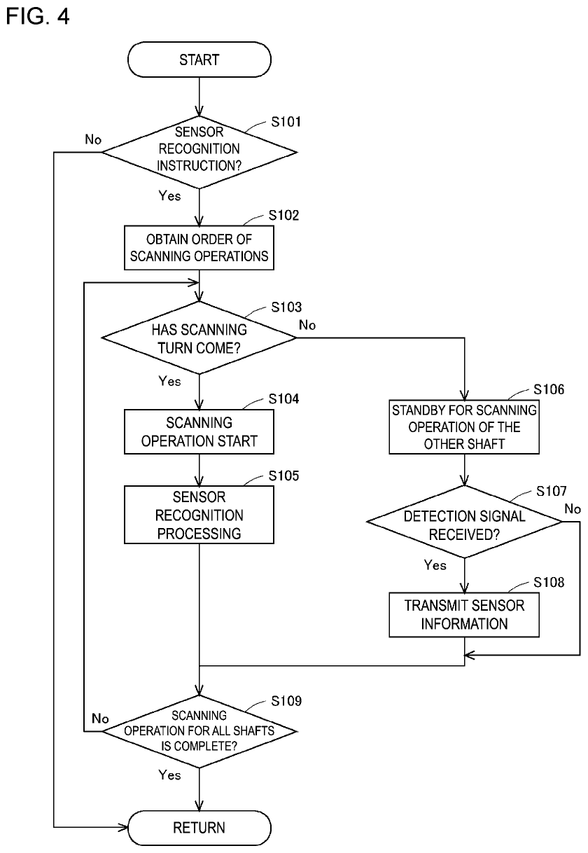

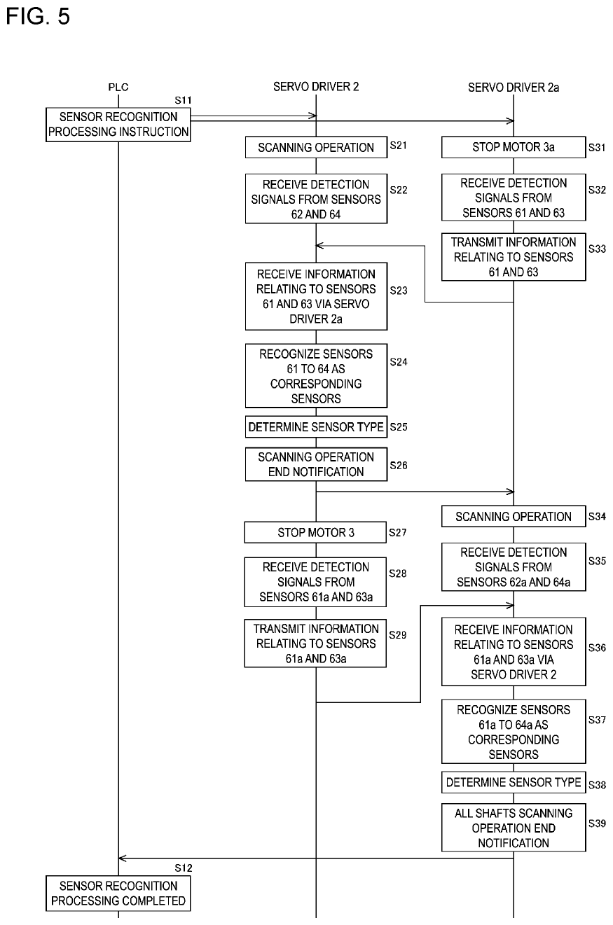

Next, sensor recognition processing implemented by cooperation between these functional units will be described with reference to FIGS. 4 and 5. FIG. 4 is a flowchart schematically illustrating the flow of processing performed by the servo drivers 2 and 2a, and FIG. 5 is a flowchart schematically illustrating the flow of processing between the PLC 1 and the servo drivers 2 and 2a when sensor recognition processing is performed.

First, the flow of processing executed by each servo driver will be described with reference to FIG. 4. The following description will focus on the servo driver 2. The processing illustrated in FIG. 4 is repeatedly executed at predetermined time intervals. First, in S101, the servo driver judges whether an instruction to perform sensor recognition processing has been received from the PLC 1. When a positive judgment is made in S101, the processing proceeds to S102. When a negative judgment is made in S101, the processing ends. In S102, in response to an instruction on the sensor recognition processing received from the PLC 1, the order of the scanning operations performed by each servo driver is acquired. Here, “scanning operations” refers to the first predetermined operation and the second predetermined operation performed for the above-described processing by the first processing unit 24 and the second processing unit 25. In other words, the scanning operation is an operation of a motor to, for each drive axis for which sensor recognition processing is performed, move a precision stage from one end portion to the other end portion of the drive axis of the motor, that is, in the full movable range, to extract the sensor that outputs a detection signal in response to a drive operation when only the corresponding motor is driven. More specifically, the motor 3 is driven at a slow and constant speed from a state in which the precision stage 53 is in contact with a stopper (not illustrated) provided at the one end portion in the movable range along the threaded axis 52 to a state in which the precision stage 53 comes into contact with a stopper (not illustrated) provided at the other end portion. Note that during this driving, torque of the motor 3 is controlled to maximally reduce impact when the precision stage 53 comes into contact with the stopper. Note that in the present embodiment, the order of the scanning operations for the drive axes scanned by the servo drivers 2 and 2a is first and second, respectively.

In S103, the servo driver judges whether it is the turn of the scanning operation by the servo driver itself, that is, the servo driver 2. When a positive judgment is made in S103, the processing proceeds to S104. When a negative judgment is made, the processing proceeds to S106. In S104, a scanning operation for the drive axis scanned by the servo driver 2, that is, a scanning operation performed by the motor 3, is started. In this case, when the scanning operation is performed in a servo system in which the limit sensor 62 is disposed at one end portion of the threaded axis 52 and the limit sensor 63 is disposed at the other end portion, the detection signals are transmitted to the servo drivers 2 and 2a from the sensors via the encoders 31 and 31a connected to the sensors in order of the limit sensor 62, the origin sensor 61, and the limit sensor 63. Furthermore, the detection signal from the full-closed sensor 64 is transmitted to the servo driver 2 the entire time the scanning operation is performed. Also, each encoder 31, 31a is provided with the display unit 316, and when detection signals from the sensors are input to each encoder, a diode of the display unit 316 lights up at the input timing of the detection signal. This allows the user to visually recognize input of the detection signals from the sensors. Note that the detection signal from each sensor includes identification information for identifying the sensor that generated the signal, and each servo driver that receives a detection signal can identify the sensor that transmitted the detection signal. When the processing of S104 is complete, the processing proceeds to S105.

In S105, sensor recognition processing is performed by the first processing unit 24 and the second processing unit 25 in accordance with the scanning operation started in S104. Specifically, when the detection signal from the limit sensor 62 and the detection signal from the full-closed sensor 64 reach the servo driver 2 due to the scanning operation, the first processing unit 24 recognizes that these sensors are sensors that correspond to the servo driver 2. Furthermore, when the detection signal from the origin sensor 61 and the detection signal from the limit sensor 62 reach the servo driver 2a due to the scanning operation, a transmitting unit (a functional unit corresponding to the transmitting unit 27 in FIG. 3) included in the servo driver 2a transmits information relating to these sensors to the servo driver 2, which is the servo driver different from the servo driver 2a, and the servo driver 2 receives the information via the communication unit 21. The information relating to the sensors includes identification information for identifying each sensor. As a result, on the basis of the received information, the second processing unit 25 recognizes that these sensors are also sensors corresponding to the servo driver 2.

Also, in S105, the judgment unit 26 judges the type of each sensor.

Specifically, since the sensor that outputs a detection signal when the position of the precision stage 53 is at the outermost position in the movable range is the limit sensors 62 and 63 among the limit sensor 62 or the limit sensor 63, the origin sensor 61, and the full-closed sensor 64, a judgment can be made on the basis of the position information of the precision stage 53 when the detection signal is output (position information indicating the outermost position) that the type of the sensor is a “limit sensor”. Also, a judgment can be made that a sensor that outputs a detection signal while the precision stage 53 is at an intermediate point in the movable range is an “origin sensor”. Also, a judgment can be made that a sensor that constantly outputs a detection signal during the scanning operation, that is, irrespective of the position of the precision stage 53 is a “full-closed sensor”. When the processing of S105 is complete, the processing proceeds to S109.

Also, in S106 after a negative judgment is made in S103, execution of a scanning operation for the other drive axis is put on standby. In the case of the present embodiment, in a case in which the scanning operation is performed for the drive axis by the servo driver 2a, the processing of S106 is performed on the servo driver 2 and the servo driver 2 is put in a standby state. However, even at this time, the servo driver 2 receives the detection signals from the origin sensor 61a and the limit sensor 63a assigned to the servo driver 2a. Because of this, in S107, the servo driver judges which either of the sensors transmitted the detection signal. Since this sensor is a sensor to be associated with a servo driver different from the servo driver 2, in a case in which a positive judgment is made in S107, the processing proceeds to S108 where sensor information relating to the sensor is transmitted by the transmitting unit 27. Note that the transmission destination of the sensor information is the servo driver corresponding to the drive axis subjected to the scanning operation at the time of receiving the detection signal. The transmission destination servo driver can transmit a query to the PLC 1 or the target servo driver 2 via the communication cable 42. When the processing of S108 ends, the processing proceeds to S109, and when a negative judgment is made in S107, the processing proceeds to S109.

In S109, the servo driver judges whether the scanning operation is complete for all of the drive axes in the servo system 100. When a positive judgment is made in S109, the processing ends, and when a negative judgment is made, the processing from S103 onward is repeated. Note that when a positive judgment is made in S109, the origin sensor 61, the limit sensors 62 and 63, and the full-closed sensor 64 are recognized as the sensors that correspond to the servo driver 2, and information relating to the association between the servo driver 2 and the sensors is stored in the storage unit 23.

Next, communication between the PLC 1 and the servo drivers 2 and 2a when the processing illustrated in FIG. 4 is performed by the servo drivers 2 and 2a will be described with reference to FIG. 5. First, in S11, an instruction on a sensor recognition processing is transmitted from the PLC 1 to both the servo drivers 2 and 2a included in the servo system 100. In response to this instruction, the processing illustrated in FIG. 4 is performed by each servo driver. Then, via the processing of S102 and S103 in FIG. 4, first in S21, the servo driver 2 drives the motor 3 to start the scanning operation (see the processing of S104 in FIG. 4). At this time, the motor 3a is stopped (see the processing of S31). Also, in S22, due to the scanning operation, the detection signals from the limit sensor 62 and the full-closed sensor 64 are received by the servo driver 2 via the encoder 31.

Furthermore, due to the scanning operation, the detection signals from the origin sensor 61 and the limit sensor 63 are received by the servo driver 2a via the encoder 31a (see the processing of S32). At this time, due to the processing of S106 illustrated in FIG. 4, the servo driver 2a is in a standby state for the scanning operation for the drive axis performed by the servo driver 2. The servo driver 2a that received the detection signals transmits, via its own transmitting unit 27, the information relating to the sensors that generated the detection signals to the servo driver 2 (see the processing of S33). Subsequently, in S23, the servo driver 2 receives the information relating to the sensors.

Thereafter, in S24, the origin sensor 61, the limit sensors 62 and 63, and the full-closed sensor 64 are recognized as sensors corresponding to the servo driver 2, and furthermore, in S25, the sensor type of each sensor is judged (see the processing in S105 in FIG. 4). The sensor recognition result and the sensor type judgment result are stored in the storage unit 23 of the servo driver 2. When the sensor type judgment is complete, in S26, the servo driver 2a for the drive axis subjected to the next scanning operation is notified that the scanning operation for the drive axis by the servo driver 2 is complete. In this manner, the servo driver 2a receives information that its turn to perform the scanning operation for its own drive axis has arrived. Note that after the notification, regarding the servo driver 2, the motor 3 is stopped (see the processing of S27), and due to the processing of S106 illustrated in FIG. 4, the servo driver 2 is put in a standby state for the scanning operation for the drive axis performed by the servo driver 2a.

Next, in S34, the motor 3a is driven by the servo driver 2a, and the scanning operation is started (see the processing of S104 in FIG. 4). Also, in S35, due to the scanning operation, the detection signals from the limit sensor 62a and the full-closed sensor 64a are received by the servo driver 2a via the encoder 31a.

Furthermore, due to the scanning operation, the detection signals from the origin sensor 61a and the limit sensor 63a are received by the servo driver 2 via the encoder 31 (see the processing of S28). The servo driver 2 that received the detection signals transmits, via its own transmitting unit 27, information relating to the sensors that generated the detection signals to the servo driver 2a (see the processing of S29). Subsequently, in S36, the servo driver 2a receives the information relating to the sensors.

Subsequently, in S37, the origin sensor 61a, the limit sensors 62a and 63a, and the full-closed sensor 64a are recognized as sensors corresponding to the servo driver 2a, and furthermore, in S38, the sensor type of each sensor is judged (see the processing in S105 in FIG. 4). The sensor recognition result and the sensor type judgment result are stored in the storage unit 23 of the servo driver 2a. When the sensor type judgment is complete, in S39, once the scanning operation for the drive axis performed by the servo driver 2a is complete, the PLC 1 is notified that the scanning operation for all of the drive axes is complete. Thus, in S12, the PLC 1 learns that the sensor recognition processing is complete.

By performing the sensor recognition processing in the servo system 100 as described above, the servo drivers 2 and 2a can recognize the sensors corresponding to each of the servo driver 2 and 2a. As a result, the detection signals from the sensors suitably arrive at each assigned servo driver. In the sensor recognition processing, each sensor need not necessarily be connected to an encoder of a motor driven by the corresponding servo driver, processing to suitably associate the servo drivers and the sensors is implemented even when the sensors are connected to an encoder of a motor located nearby. This reduces the burden of wiring the sensors, and thus, it is easy to construct the servo system 100 for servo control of the drive axes.

### Second Embodiment

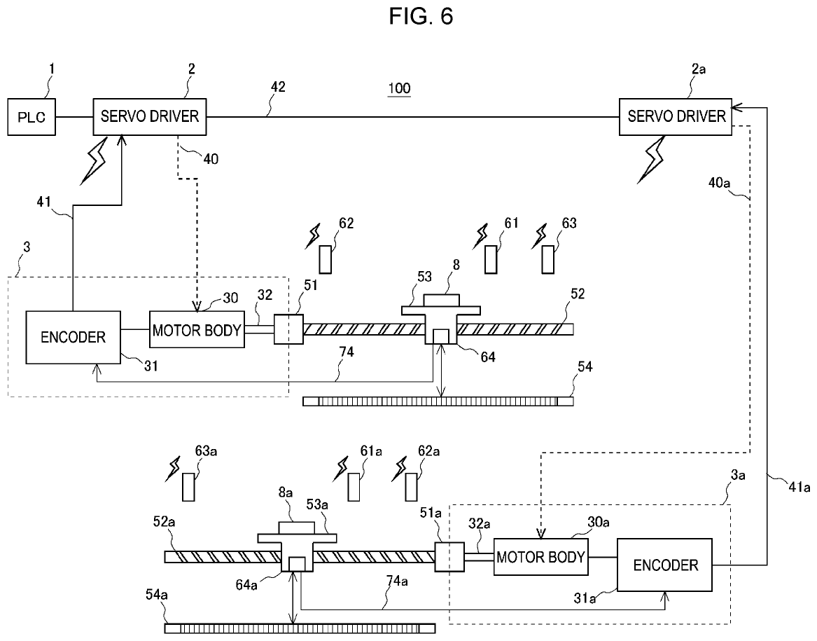

A second embodiment of the present disclosure will be described with reference to FIG. 6. FIG. 6 is a block diagram schematically illustrating an example of the configuration of the servo system 100 of the present embodiment. The encoder 31a has a similar configuration as that of the encoder 31.

In the present embodiment, some of the sensors disposed at the drive axes have a wireless communication function. In the first embodiment described above, the detection signals from the sensors are input into the encoders 31 and 31a of the motors 3 and 3a and then transmitted to the servo drivers 2 and 2a via the encoder cables 41 and 41a, respectively. However, in the present embodiment, the detection signals are transmitted to the corresponding servo driver via wireless communication. In this example also, to perform servo control on the motors 3 and 3a by the servo control unit 22 using the detection signals from the sensors, the detection signals from the sensors need to be appropriately transmitted to the assigned servo driver 2, 2a. To do this, the servo drivers 2 and 2a need to appropriately recognize the corresponding sensors.

Here, the configuration of the servo system 100 of the present embodiment will be described with reference to FIG. 6. Regarding the drive axis of the precision stage 53 driven by the motor 3, that is, the drive axis scanned by the servo driver 2, the origin sensor 61 and the limit sensors 62 and 63 have a wireless communication function. On the other hand, the full-closed sensor 64 is connected to the encoder 31 via the cable 74 as in the first embodiment. In this manner, only the detection signal from the full-closed sensor 64 is input into the input unit 312 of the encoder 31, and electric power is supplied to the full-closed sensor 64 from the power supply unit 315. Also, the communication unit 21 of the servo driver 2 has a communication function for enabling wireless communication with the origin sensor 61 and the limit sensors 62 and 63. Note that the sensors that have a wireless communication function include an internal battery and do not receive a supply of electric power from the outside. Also, in an example using another method, each sensor may be configured to receive a supply of electric power from the outside (including the encoder 31, for example) via a non-illustrated power line.

Also, regarding the drive axis of the precision stage 53a driven by the motor 3a, that is, the drive axis scanned by the servo driver 2a, the origin sensor 61a and the limit sensors 62a and 63a have a wireless communication function. On the other hand, the full-closed sensor 64a is connected to the encoder 31a via the cable 74a as in the first embodiment. In this manner, only the detection signal from the full-closed sensor 64a is input into the input unit 312 of the encoder 31a, and electric power is supplied to the full-closed sensor 64a from a power supply unit 315. Further, the communication unit of the servo driver 2a has a communication function for enabling wireless communication with the origin sensor 61a and the limit sensors 62a and 63a.

Here, it is assumed that each sensor having a wireless function has not been subjected to recognition processing by the servo drivers 2 and 2a. In such a state, the detection signals from the sensors having a wireless function can be wirelessly received by the servo drivers 2 and 2a. However, the servo drivers do not know what detection signal from which sensor is assigned to them. Thus, in this state, servo control cannot be performed on the motors by the servo drivers. Thus, association between the servo drivers and the sensors can be suitably implemented by applying the sensor recognition processing described in the first embodiment to the servo system 100 in a state in which the sensor recognition processing performed by the servo drivers is not complete. In the case of the present embodiment, since the detection signals from the sensors having a wireless function are received by all of the servo drivers even before completion of the sensor recognition processing, the servo drivers do not need to include a functional unit corresponding to the transmitting unit 27 described in the first embodiment.

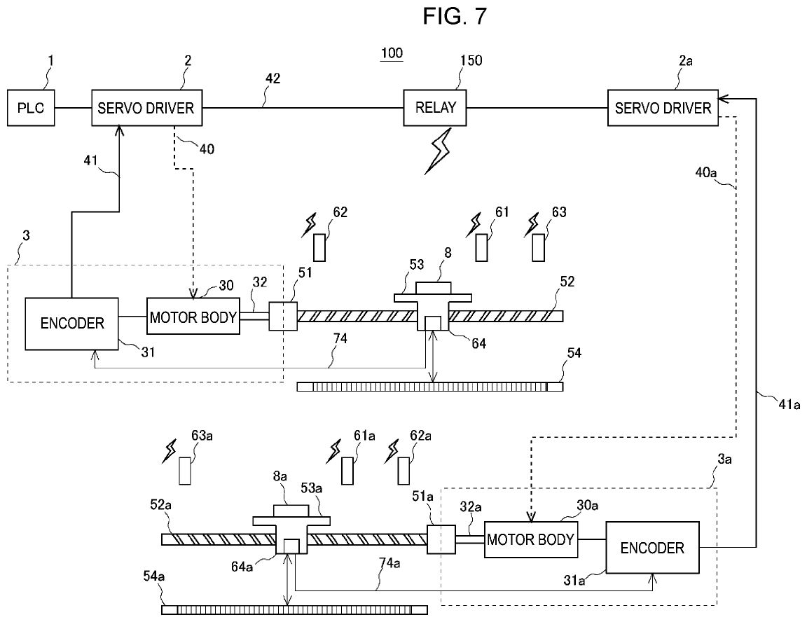

Further, a modified example of the present embodiment will be described with reference to FIG. 7. FIG. 7 is a block diagram schematically illustrating an example of the configuration of the servo system 100, similar to FIG. 6. In the present modified example, the detection signals from the sensors are wirelessly received once at a relay 150 before then being delivered from the relay 150 to the servo drivers 2 and 2a. In other words, the communication unit 21 of each servo driver 2, 2a does not have a wireless function. However, in this example also, to perform servo control on the motors 3 and 3a by the servo control unit 22 using the detection signals from the sensors, the detection signals from the sensors need to be appropriately transmitted to the assigned servo driver 2, 2a. To do this, the servo drivers 2 and 2a need to appropriately recognize the corresponding sensors. Thus, association between the servo drivers and the sensors can be suitably implemented by applying the sensor recognition processing described in the first embodiment, similar to the second embodiment described above.

### Third Embodiment

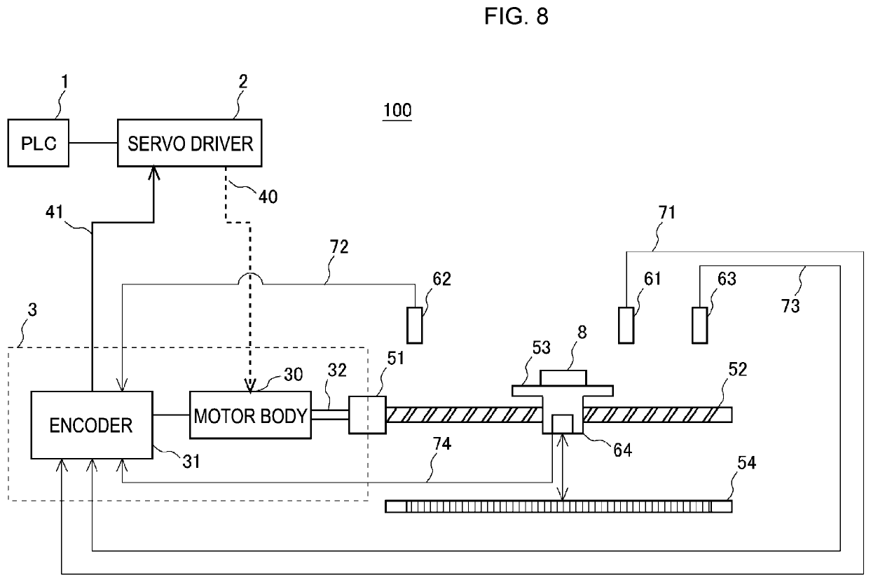

A third embodiment of the present disclosure will be described with reference to FIG. 8. FIG. 8 is a block diagram schematically illustrating an example of the configuration of the servo system 100 of the present embodiment. In the servo system 100 of the present embodiment, only one drive axis is provided. Thus, different to the first embodiment, the origin sensor 61 and the limit sensor 63 are connected to the encoder 31 via the cables 71 and 73, respectively. With such a configuration, the detection signals from the origin sensor 61 and the limit sensor 63 are transmitted to the encoder 31, and electric power is supplied to the origin sensor 61 and the limit sensor 63 from the encoder 31.

The sensor recognition processing illustrated in FIG. 4 can be substantially applied to this system configuration. However, since the servo system 100 includes only one drive axis, only one drive axis is subjected to the scanning operation, that is, only the scanning operation by the motor 3 is performed. Further, the detection signals from the origin sensor 61 and the limit sensors 62 and 63 acquired according to the scanning operation are all first transmitted to the servo driver 2, and then sensor recognition processing according to S105 is performed as described above. Since there are no other drive axes, the processing of S106 to S108 illustrated in FIG. 4 is not performed. As a result, even in the servo system 100 including a solitary drive axis, the sensor recognition processing is suitably implemented.

<Supplement 1>

A servo driver (2) configured to drive a first motor (3) and be communicatively connected to a different servo driver (2a), the servo driver (2) and a first sensor (62, 64) that is configured to detect a parameter relating to displacement of a first drive target (53) driven via an output axis (32) of the first motor (3) being in an arrangement such that a detection signal from the first sensor (62, 64) is received by the servo driver (2), and the different servo driver (2a) and a different sensor (61, 63) that is configured to detect a different parameter relating to displacement of the drive target (53) being in an arrangement such that a detection signal from the different sensor (61, 63) is received by the different servo driver (2a),

the servo driver (2) including:

a first processing unit (24) configured to, in a case in which the servo driver (2) receives a detection signal from the first sensor (62, 64) when a first predetermined operation of driving only the output axis (32) of the first motor (3) to displace the first drive target (53) is performed in a state in which sensor recognition processing is not complete, recognize the first sensor (62, 64) as a first corresponding sensor associated with the servo driver (2); and

a second processing unit (25) configured to, in a case in which the servo driver (2) receives, from the different servo driver (2a), predetermined information relating to the different sensor (61, 63) for enabling the servo driver (2) to recognize the different sensor (61, 63) as a different corresponding sensor associated with the servo driver (2) when the first predetermined operation is performed in a state in which sensor recognition processing is not complete, recognize the different sensor (61, 63) as the different corresponding sensor on the basis of the predetermined information.

<Supplement 2>

A servo driver (2) configured to drive a first motor (3),

wherein the first motor (3) includes

a motor body (30) including an output axis (32), and

an encoder (31) including a signal generation unit configured to detect an operation of the motor body (30) driven by the servo driver (2) and generate a feedback signal indicating a detected operation,

a first sensor (62, 64) configured to detect a parameter relating to displacement of a first drive target (53) driven via the output axis (32) of the first motor (3) is connected to the encoder (31) via a sensor cable (72, 74), and via this connection, a detection signal from the first sensor (62, 64) is transmitted to the encoder (31), and the first sensor (62, 64) is supplied with electric power from the encoder (31) via the sensor cable (72, 74), and the servo driver (2) acquires, via a communication cable (41) connected to the encoder (31), the feedback signal generated by the signal generation unit and a detection signal from the first sensor (62, 64) transmitted via the sensor cable (72, 74).

<Supplement 3>

A servo system (100) includes:

a first servo driver (2) configured to drive a first motor (3); and

a second servo driver (2a) communicatively connect to the first servo driver (2) and configured to drive a second motor (3a),

wherein the first servo driver (2) is configured to receive a detection signal from a first sensor (62, 64) configured to detect a parameter relating to displacement of a first drive target (53) driven via an output axis (32) of the first motor (3),

the second servo driver (2a) is configured to receive a detection signal from a different sensor (61, 63) configured to detect a different parameter relating to displacement of the first drive target (53),

the second servo driver (2a) is configured to, in a case in which the second servo driver (2a) receives the detection signal from the different sensor (61, 63) when a first predetermined operation of driving only the output axis (32) of the first motor (3) to displace the first drive target (32) is performed in a state in which sensor recognition processing is not complete, transmit to the first servo driver (2) information relating to the different sensor (61, 63) for enabling the first servo driver (2) to recognize the different sensor (61, 63) as a different corresponding sensor associated with the first servo driver (2), and

the first servo driver (2) is configured to recognize the different sensor (61, 63) as the different corresponding sensor on the basis of the information relating to the different sensor (61, 63).

<Supplement 4>

A sensor recognition processing method executed by a servo system (100) including a first servo driver (2) configured to drive a first motor (3) and a second servo driver (2a) communicatively connected to the first servo driver (2) and configured to drive a second motor (3a), the first servo driver (2) being configured to receive a detection signal from a first sensor (62, 64) configured to detect a parameter relating to displacement of a first drive target (53) driven via an output axis (32) of the first motor (3), and the second servo driver (2a) being configured to receive a detection signal from a different sensor (61, 63) configured to detect a different parameter relating to displacement of the first drive target (53), the method including:

transmitting, in a case in which the second servo driver (2a) receives the detection signal from the different sensor (61, 63) when a first predetermined operation of driving only the output axis (32) of the first motor (3) to displace the first drive target (53) is performed in a state in which sensor recognition processing is not complete, from the second servo driver (2a) to the first servo driver (2) information relating to the different sensor (61, 63) for enabling the first servo driver (2) to recognize the different sensor (61, 63) as a different corresponding sensor associated with the first servo driver (2), and

recognizing the different sensor (61, 63) as the different corresponding sensor on the basis of the information relating to the different sensor (61, 63) by the first servo driver (2).

### DESCRIPTION OF SYMBOLS

1 PLC
2, 2a servo driver
3, 3a motor
24 first processing unit
25 second processing unit
26 judgment unit
27 transmitting unit
30, 30a motor body
31, 31a encoder
32, 32a output axis
53, 53a precision stage
54, 54a linear scale
61, 61a origin sensor
62, 62a, 63, 63a limit sensor
64, 64a full-closed sensor
100 servo system
150 relay
311 signal generation unit
312 input unit
314 communication unit
315 power supply unit
316 display unit

1. A servo driver configured to drive a first motor and be communicatively connected to a different servo driver,
the servo driver and a first sensor that is configured to detect a parameter relating to displacement of a first drive target driven via an output axis of the first motor being in an arrangement such that a detection signal from the first sensor is received by the servo driver, and the different servo driver and a different sensor that is configured to detect a different parameter relating to displacement of the first drive target being in an arrangement such that a detection signal from the different sensor is received by the different servo driver,
the servo driver comprising:
a first processing unit configured to, in a case in which the servo driver receives a detection signal from the first sensor when a first predetermined operation of driving only the output axis of the first motor to displace the first drive target is performed in a state in which sensor recognition processing is not complete, recognize the first sensor as a first corresponding sensor associated with the servo driver; and
a second processing unit configured to, in a case in which the servo driver receives, from the different servo driver, predetermined information relating to the different sensor for enabling the servo driver to recognize the different sensor as a different corresponding sensor associated with the servo driver when the first predetermined operation is performed in a state in which sensor recognition processing is not complete, recognize the different sensor as the different corresponding sensor on the basis of the predetermined information.

2. The servo driver according to claim 1,
wherein the server driver and a second sensor that is configured to detect a parameter relating to displacement of a second drive target driven via an output axis of a second motor by a second servo driver communicatively connected to the servo driver are in an arrangement such that a detection signal from the second sensor is received by the servo driver, and
the servo driver further includes
a transmitting unit configured to, in a case in which the servo driver receives the detection signal from the second sensor when a second predetermined operation of driving only the output axis of the second motor to displace the second drive target is performed in a state in which the sensor recognition processing is not complete, transmit to the second servo driver information relating to the second sensor for enabling the second servo driver to recognize the second sensor as a second corresponding sensor associated with the second servo driver.

3. The servo driver according to claim 2,
wherein the different servo driver is the second servo driver.

4. The servo driver according to claim 1,
wherein the first motor includes
a motor body including the output axis, and
an encoder including a signal generation unit configured to detect an operation of the motor body driven by the servo driver and generate a feedback signal indicating a detected operation,
the first sensor is connected to the encoder via a sensor cable, and
the servo driver acquires, via a communication cable connected to the encoder, the feedback signal generated by the signal generation unit and the detection signal from the first sensor transmitted via the sensor cable.

5. The servo driver according to claim 4,
wherein the first sensor is supplied with electric power from the encoder via the sensor cable.

6. The servo driver according to claim 4,
wherein the encoder includes a display unit configured to indicate, when a detection signal is input from the first sensor via the sensor cable, that the input is received.

7. The servo driver according to claim 1,
wherein the first sensor is wirelessly communicatively connected to the servo driver or wirelessly communicatively connected to the servo driver via a predetermined device configured to communicate with the first sensor, and
the servo driver wirelessly acquires the detection signal from the first sensor or acquires the detection signal from the first sensor via the predetermined device.

8. The servo driver according to claim 1,
wherein the first predetermined operation is an operation in which the first drive target moves a full drivable range of the first drive target starting from one end portion and reaching another end portion.

9. The servo driver according to claim 1, further comprising
a judgment unit configured to judge a sensor type of the first sensor recognized by the first processing unit and the different sensor recognized by the second processing unit, on a basis of position information in a drive range of the first drive target when each of the first sensor and the different sensor is recognized.

10. A servo driver configured to drive a first motor,
wherein the first motor includes
a motor body including an output axis, and
an encoder including a signal generation unit configured to detect an operation of the motor body driven by the servo driver and generate a feedback signal indicating a detected operation,
a first sensor configured to detect a parameter relating to displacement of a first drive target driven via the output axis of the first motor is connected to the encoder via a sensor cable, and via this connection, a detection signal from the first sensor is transmitted to the encoder and the first sensor is supplied with electric power from the encoder via the sensor cable, and
the servo driver acquires, via a communication cable connected to the encoder, the feedback signal generated by the signal generation unit and the detection signal from the first sensor transmitted via the sensor cable.

11. A servo system comprising:
a first servo driver configured to drive a first motor; and
a second servo driver communicatively connected to the first servo driver and configured to drive a second motor,
wherein the first servo driver is configured to receive a detection signal from a first sensor configured to detect a parameter relating to displacement of a first drive target driven via an output axis of the first motor,
the second servo driver is configured to receive a detection signal from a different sensor configured to detect a different parameter relating to displacement of the first drive target,
the second servo driver is configured to, in a case in which the second servo driver receives the detection signal from the different sensor when a first predetermined operation of driving only the output axis of the first motor to displace the first drive target is performed in a state in which sensor recognition processing is not complete, transmit to the first servo driver information relating to the different sensor for enabling the first servo driver to recognize the different sensor as a different corresponding sensor associated with the first servo driver, and
the first servo driver is configured to recognize the different sensor as the different corresponding sensor on the basis of the information relating to the different sensor.

12. The servo system according to claim 11,
wherein the first servo driver is further configured to, in a case in which the first servo driver receives the detection signal from the first sensor when the first predetermined operation is performed in a state in which sensor recognition processing is not complete, recognize the first sensor as a first corresponding sensor associated with the first servo driver.

13. The servo system according to claim 11,
wherein the first servo driver is further configured to receive a detection signal from a second sensor configured to detect a parameter relating to displacement of a second drive target driven via an output axis of the second motor, and
the first servo driver is further configured to, in a case in which the first servo driver receives the detection signal from the second sensor when a second predetermined operation of driving only the output axis of the second motor to displace the second drive target is performed in a state in which sensor recognition processing is not complete, transmit to the second servo driver information relating to the second sensor for enabling the second servo driver to recognize the second sensor as a second corresponding sensor associated with the second servo driver.

14. The servo system according to claim 11,
wherein the first motor includes
a motor body including the output axis, and
an encoder including a signal generation unit configured to detect an operation of the motor body driven by the servo driver and generate a feedback signal indicating a detected operation,
the first sensor is connected to the encoder via a sensor cable, and
the servo driver acquires, via a communication cable connected to the encoder, the feedback signal generated by the signal generation unit and a detection signal from the first sensor transmitted via the sensor cable.

15. A sensor recognition processing method executed by a servo system including a first servo driver configured to drive a first motor and a second servo driver communicatively connected to the first servo driver and configured to drive a second motor, the first servo driver being configured to receive a detection signal from a first sensor configured to detect a parameter relating to displacement of a first drive target driven via an output axis of the first motor, and the second servo driver being configured to receive a detection signal from a different sensor configured to detect a different parameter relating to displacement of the first drive target, the method comprising:
transmitting, in a case in which the second servo driver receives the detection signal from the different sensor when a first predetermined operation of driving only the output axis of the first motor to displace the first drive target is performed in a state in which sensor recognition processing is not complete, from the second servo driver to the first servo driver information relating to the different sensor for enabling the first servo driver to recognize the different sensor as a different corresponding sensor associated with the first servo driver, and
recognizing the different sensor as the different corresponding sensor on the basis of the information relating to the different sensor by the first servo driver.
